(19) United States
(12) Patent Application Publication
(10) Pub. No.: US 2012/0284302 A1
(43) Pub. Date: Nov. 8, 2012

(54) CONTENT SELECTION SYSTEM, CONTENT SELECTION METHOD AND PROGRAM

(76) Inventors: Tsuyoshi Takagi, Tokyo (JP); Hiroki Kato, Tokyo (JP); Takayuki Sakamoto, Tokyo (JP)

(21) Appl. No.: 13/503,308

(22) PCT Filed: Oct. 19, 2010
(86) PCT No.: PCT/JP2010/068352

§ 371 Date: Jul. 10, 2012

(30) Foreign Application Priority Data
Oct. 29, 2009 (JP) 2009-248890

(51) Int. Cl. G06F 17/30

(52) U.S. Cl. 707/769; 707/705; 707/E17.001; 707/E17.014

(57) ABSTRACT

Provided is a content selection system comprising a content selecting device which selects more than one content from a plurality of contents using selectively and sequentially any one of a plurality of selection standards that are mutually different from each other, and a controlling device which uses a selection standard different from a selection standard used for selecting said more than one content so that the content selecting selects more than one content from the plurality of contents when the content selecting uses any one of the selection standards and there is an operation to indicate a user's prescribed evaluation on any of more than one content to be reproduced.

### TECHNICAL FIELD

The present invention relates to a content selection system, a content selection method and a program.

### BACKGROUND ART

In recent years, a user can obtain one's desired video and music from a huge amount of contents through a communication network such as internet, and view them. This leads various proposals regarding recommendation technology that predicts and provides user's preference in such huge amount of contents. For example, a content-based filtering extracts features of contents the user preferred in the past, and recommends contents that are close to the feature.

### SUMMARY OF INVENTION

### Technical Problem

However, in conventional technology, recommendation standard is static and there has been a problem that recommendation itself were easy to be routine. In addition, even if the user gives positive or negative evaluation on recommended contents, the evaluation gradually changes the user's feature and only gradually changes contents to be recommended, which does not motivate the user to actively provide evaluations.

The present invention is made in view of the above issues, and it is an object of the present invention to provide a content selection system, a content selection method and a program, which selects content based on various standards and motivates a user to actively evaluate the contents, as well.

### Solution to Problem

According to the first aspect of the present invention in order to achieve the above-mentioned object, there is provided a content selection system including a content selecting device which selects more than one content from a plurality of contents using selectively and sequentially any one of a plurality of selection standards that are mutually different from each other, and a controlling device which uses a selection standard different from a selection standard used for selecting said more than one content so that the content selecting selects more than one content from the plurality of contents when the content selecting uses any one of the selection standards and there is an operation to indicate a user's prescribed evaluation on any of more than one content to be reproduced.

When it is satisfied with condition to end content selection using any of the selection standards, the controlling device may use a selection standard different from said selection standard so that the content selecting device selects more than one contents.

It may further include a content reproducing device that reproduces the more than one content when the content selecting uses any of selection standards to select more than one content.

The plurality of selection standards may include a first selection standard, and the controlling device may use the first selection standard so that the content selecting device to select more than one content when there is an operation to indicate an user's positive evaluation on any of more than one content that is selected using a selection standard other than the first selection standard. The first selection standard may use a first attribute of a content which corresponds to the operation indicating a positive evaluation.

It may further include a short-term positive feature vector storing device that stores more than one short-term positive feature vector based on features of a content corresponding to each of more than one positive operation during a prescribed period after an operation indicating an user's positive evaluation. The first selection standard may use the more than one short-term positive feature vector that is stored by the storing device.

The plurality of selection standards may include a second selection standard, and the controlling device may use the second selection standard so that the content selecting device to select more than one content when ending reproducing of the more than one content that is selected using the first selection standard. At this time, the content selection system may use a second attribute different from the first attribute of a content corresponding to the second selection standard and the operation indicating a positive evaluation.

The plurality of selection standards may include a third selection standard, and the controlling device may use the third selection standard so that the content selecting device to select more than one content when there is an operation to indicate an user's negative evaluation on any of more than one content that is selected using a selection standard other than the third selection standard. At this time, the third selection standard may use random numbers.

A content selection method according to the present invention includes the steps of a content selecting step which selects more than one content from a plurality of contents using selectively and sequentially any one of a plurality of selection standards that are mutually different from each other, and a controlling step which uses a selection standard different from a selection standard used for selecting said more than one content so that the content selecting selects more than one content from the plurality of contents when the content selecting uses any one of the selection standards and there is an operation to indicate a user's prescribed evaluation on any of more than one content to be reproduced.

A content selection apparatus according to the present invention includes a query generating device which generates a query to select more than one content from a plurality of contents using selectively and sequentially any one of a plurality of selection standards that are mutually different from each other, and a controlling device that controls generating a query for selecting more than one content from the plurality of contents using a selection standard different from a selection standard used for selecting the more than one content when there is an operation which is selected by a query generated by the query generating device and which indicates a user's prescribed evaluation on any of the more than one content to be reproduced.

A program according to the present invention may cause a computer to function as a query generating device which generates a query to select more than one content from a plurality of contents using selectively and sequentially any one of a plurality of selection standards that are mutually different from each other, and a controlling device that controls generating a query for selecting more than one content from the plurality of contents using a selection standard different from a selection standard used for selecting the more than one content when there is an operation which is selected by a query generated by the query generating device and which indicates a user's prescribed evaluation on any of the more than one content to be reproduced. The program may be stored in information storage medium which is capable of computer readable such as CD-ROM or DVD-ROM.

### Advantageous Effects of Invention

According to the present invention, there is provided a content selection system, a content selection apparatus, a content selection method and a program, which are capable of selecting contents based on various standards and further motivating a user to actively evaluate the contents.

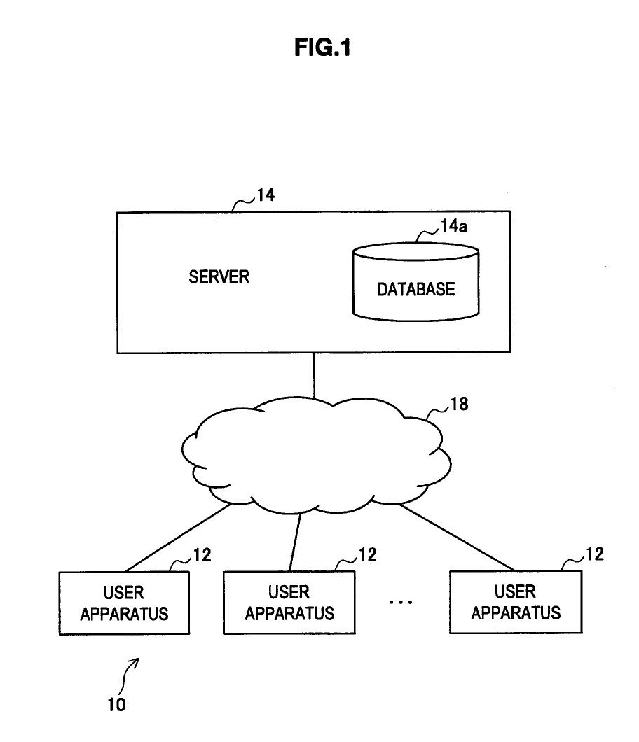

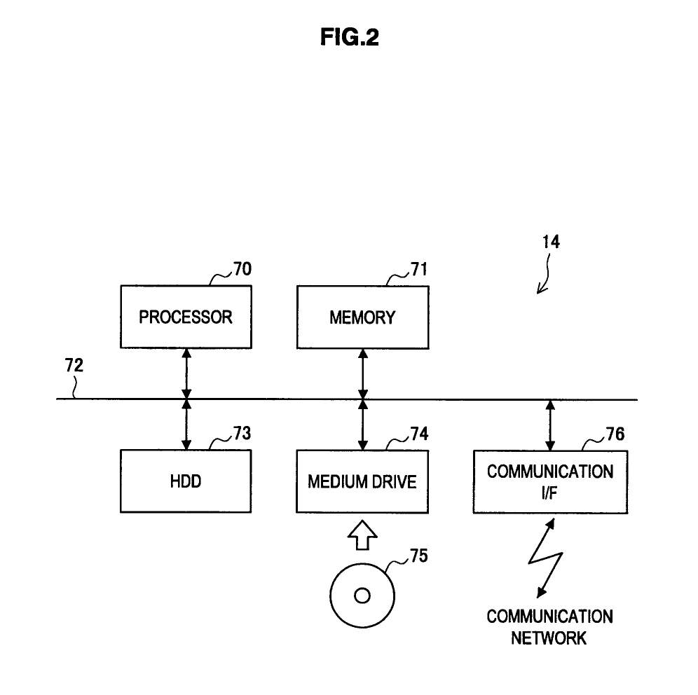

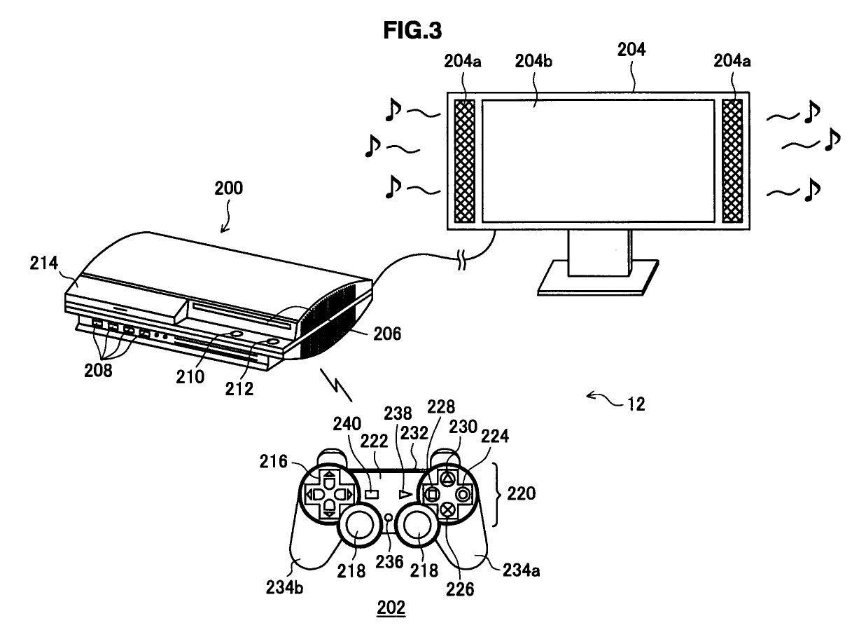

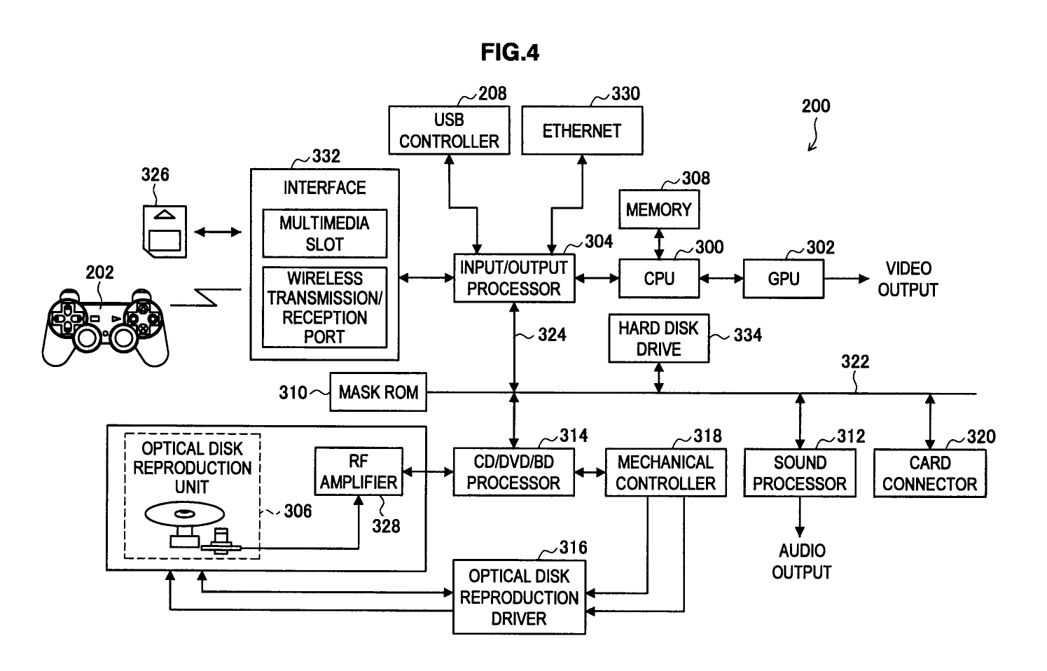

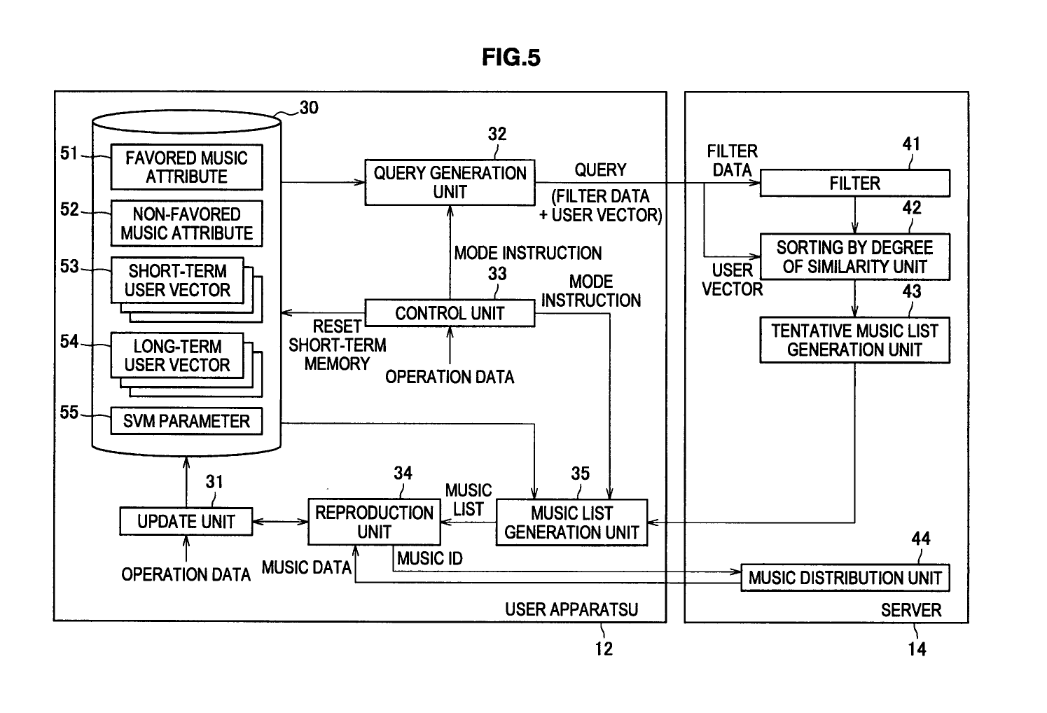

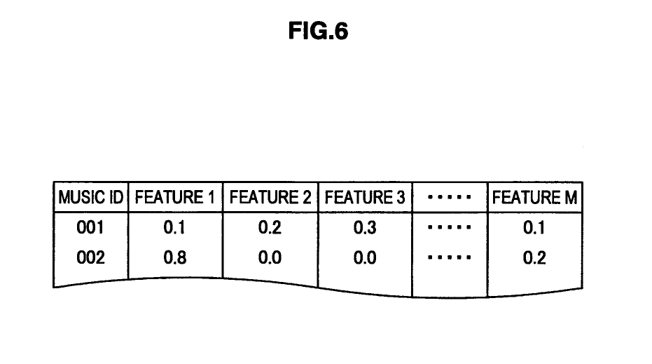

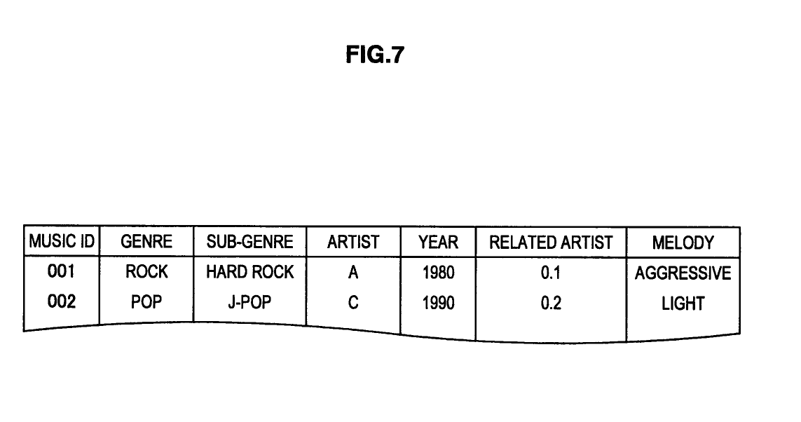

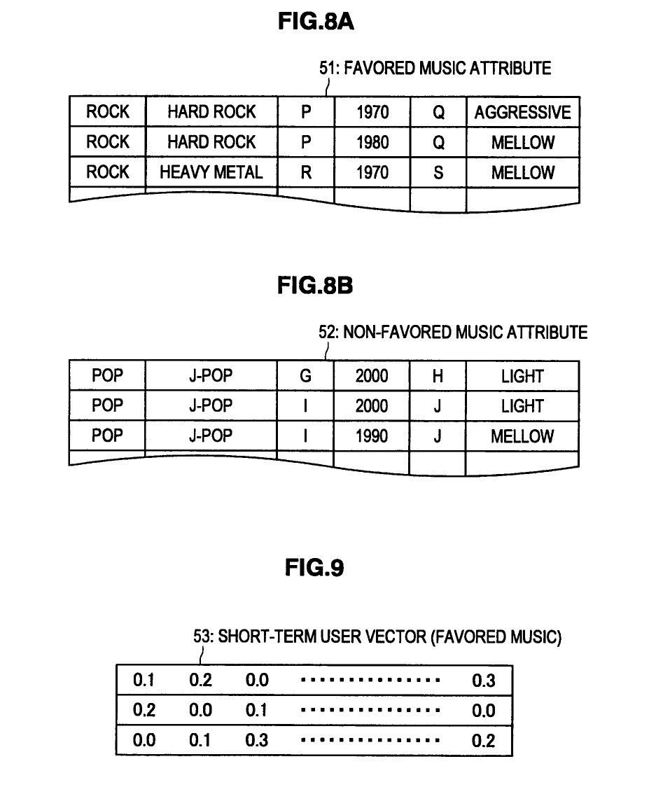

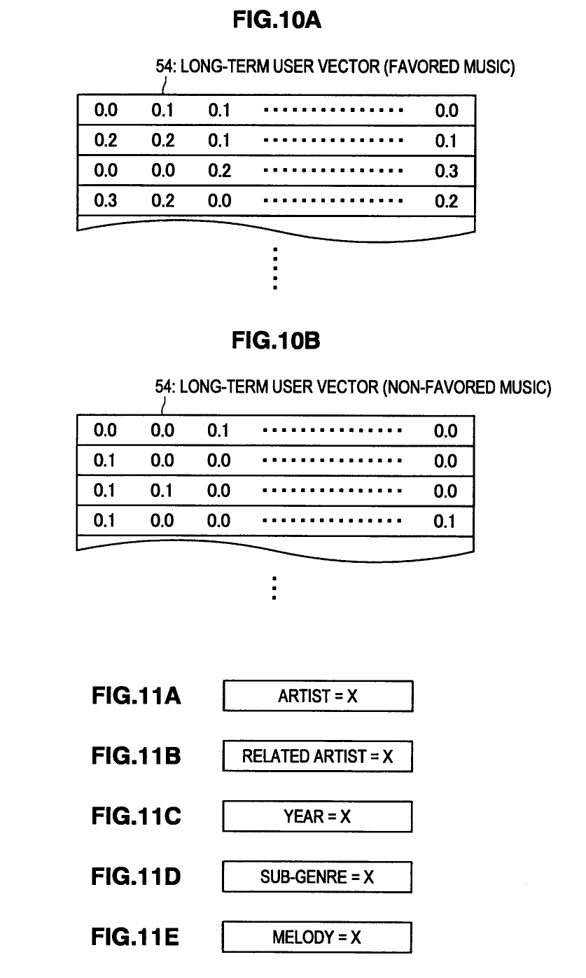

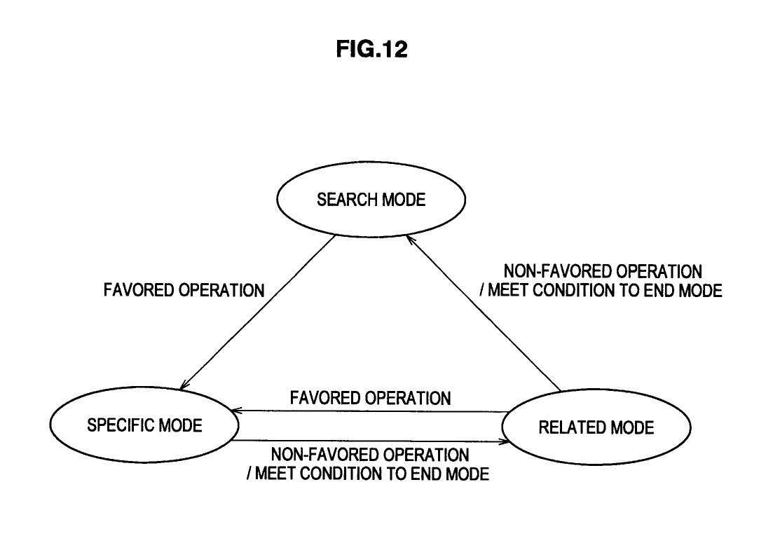

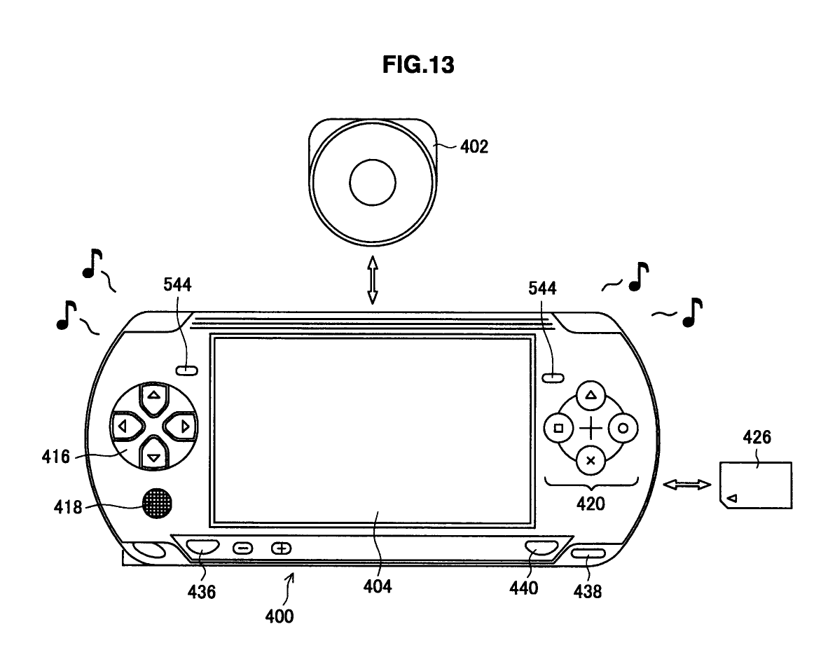

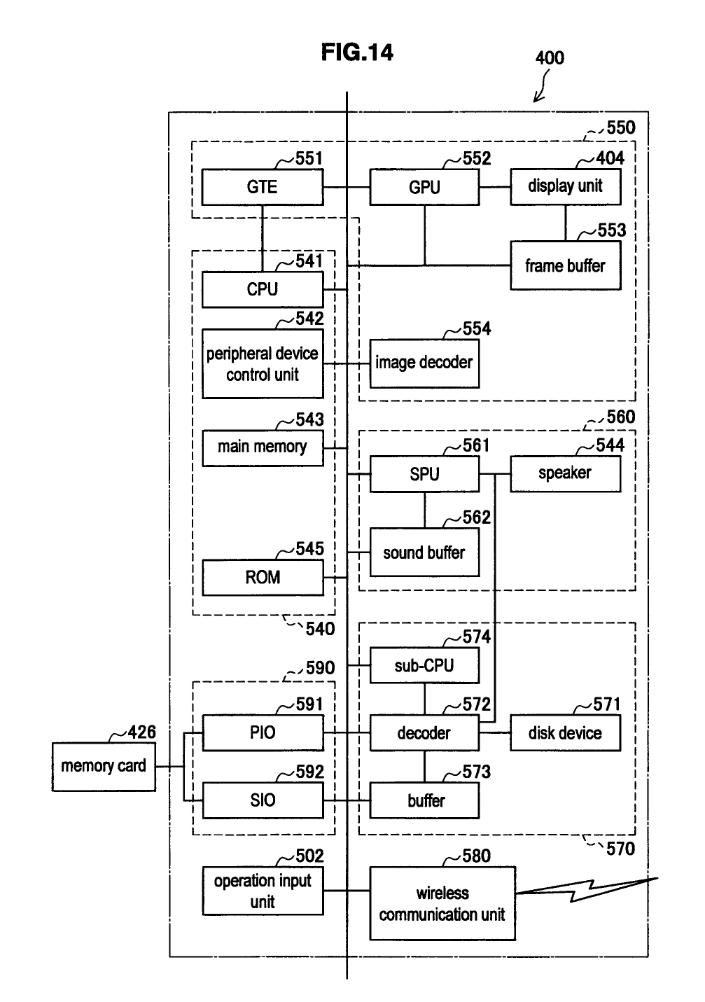

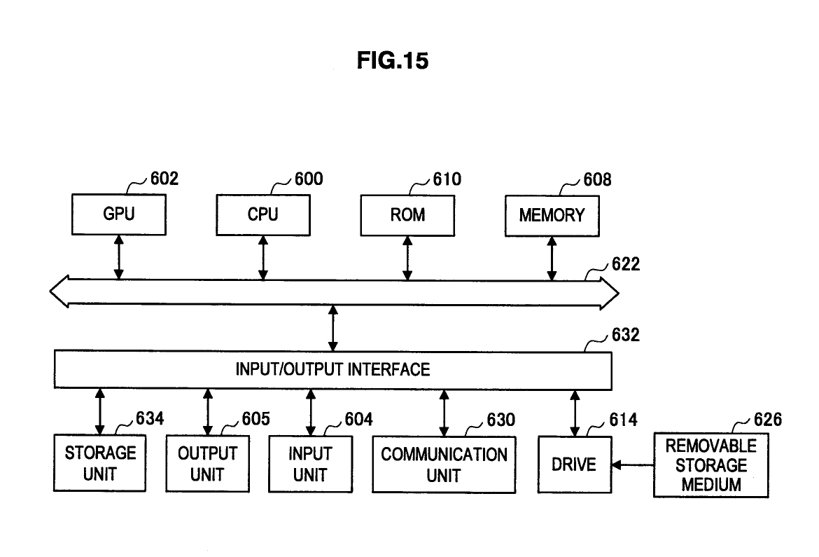

### BRIEF DESCRIPTION OF DRAWINGS

[FIG. 1] FIG. 1 is an overall configuration diagram illustrating a content distribution system according to an embodiment of the present invention.

[FIG. 2] FIG. 2 is a hardware configuration diagram illustrating a server.

[FIG. 3] FIG. 3 is a perspective view illustrating an external appearance of a game system used as a user apparatus.

[FIG. 4] FIG. 4 is a hardware configuration diagram illustrating a game machine.

[FIG. 5] FIG. 5 is a functional block diagram illustrating a user apparatus.

[FIG. 6] FIG. 6 is a diagram schematically illustrating music feature data that is stored in a server.

[FIG. 7] FIG. 7 is a diagram schematically illustrating music attribute data that is stored in a server.

[FIG. 8] FIG. 8 is a diagram schematically illustrating favored music attribute and non-favored music attribute that are stored in an user apparatus.

[FIG. 9] FIG. 9 is a diagram schematically illustrating a short-term user vector related to favored music that is stored in the user apparatus for a short-term.

[FIG. 10] FIG. 10 is a diagram schematically illustrating a long-term user vector related to favored music in a specific genre that is stored in the user apparatus for a long-term.

[FIG. 11] FIG. 11 is a diagram schematically illustrating a filter.

[FIG. 12] FIG. 12 is a diagram explaining transition of action mode in the user apparatus.

[FIG. 13] FIG. 13 is an external view illustrating a portable game machine.

[FIG. 14] FIG. 14 is a hardware configuration diagram illustrating a portable game machine.

[FIG. 15] FIG. 15 is a hardware configuration diagram illustrating a general-purpose personal computer.

### DESCRIPTION OF EMBODIMENTS

An embodiment of the present invention will be hereinafter explained in detail with reference to drawings.

FIG. 1 is an overall configuration diagram illustrating a content distribution system according to an embodiment of the present invention. As shown in this figure, this content distribution system 10 is an implementing example of a content selection system according to the present invention, is connected to a data communication network 18 such as the Internet, and includes a server 14 capable of mutual data communication and a plurality of user apparatuses 12 (a content distribution apparatus). The server 14 includes a database 14a. For example, the user apparatus 12 may be a computer system installed in each home such as a personal computer, a computer game system, and a home server, and a portable machine such as a portable game machine, which transmits a query for selecting music (a query for favored music and a query for non-favored music) and receives a music list (a tentative favored music list and a tentative non-favored music list). Then, it generates a music list from those lists. The user apparatus 12 requests the server 14 for music data included in the music list, and receives it to reproduce. On the other hand, for example, the server 14 is configured from a computer system such as unknown server computer, generates a tentative favored music list and a tentative non-favored music list according to the query transmitted from each user apparatus 12, and replies to it. Meanwhile the server 14 is, for example, configured from a computer system such as a publicly known server computer, generates a tentative favored music list and a tentative non-favored music list according to queries transmitted from each user apparatus 12, and replies them thereto. In addition, the server 14 stores huge amount of music data in relation to the music ID, and distributes music data in response to requests from each user apparatus 12. Note that here an example to be explained is a case where the present invention is applied to distribution of music, however, the present invention is not limited thereto. It is to be understood that the present invention may be applied to distribution of various kinds of contents, e.g., a motion image such as a movie, a still image such as a picture, and a document such as a novel.

FIG. 2 is a figure illustrating an example of hardware configuration of the server 14. As shown in this figure, the server 14 includes a processor 70, a memory 71, a hard disk drive 73, a medium drive 74, and a communication interface 76, which are connected to a bus 72 so as to mutually exchange data. The memory 71 includes a ROM and a RAM. The ROM stores various kinds of system programs. The RAM is mainly used for a work area of the processor 70. The hard disk drive 73 stores a program for distributing music and distributing a list of tentative music, and the database 14a is structured for distributing music and distributing a list of tentative music. The medium drive 74 is a device for reading data stored in a computer-readable medium 75 such as a CD-ROM and a DVD-RAM, or writing data to the computer-readable medium 75. The communication interface 76 controls data communication via the communication network 18 with the user apparatus 12. The processor 70 controls each unit of the server 14 according to a program stored in the memory 71, the hard disk drive 73, or the medium 75.

Subsequently, the user apparatus 12 will be explained in detail. FIG. 3 is an external view illustrating a computer game system used as the user apparatus 12. This computer game system includes a game machine 200, an operation device 202, and a television monitor 204. The game machine 200 is a computer game system, which executes not only game programs but also various kinds of programs such as a Web browser and movie/music player programs. The program may be read from various kinds of computer-readable media such as various kinds of optical disks, internal or external hard disk drives, and semiconductor memories, or may be downloaded via a computer network such as the Internet. The operation device 202 is wirelessly communicatively connected to the game machine 200 or communicatively connected thereto via a wire.

The game machine 200 includes a disk insertion slot 206 compatible with optical disks, a USB connection terminal 208, and the like. The disk insertion slot 206 is configured such that optical disks such as a BD (Blu-ray disk, trademark), a DVD-ROM, and a CD-ROM can be loaded in the slot. A touch sensor 210 is used to instruct the game machine 200 to unload a disk. A touch sensor 212 is used to instruct the game machine 200 to turn the power on or off. A power switch, an audio and video output terminal, an optical digital output terminal, an AC power input terminal, a LAN connector, an HDMI terminal, and the like (not shown) are provided at the rear side of the game machine 200.

The game machine 200 is also provided with a multimedia slot for receiving multiple types of detachable semiconductor memories. Multiple slots, not shown, are exposed to receive respectively different types of semiconductor memories, when a lid 214 arranged on the front surface of the game machine 200 is opened.

The operation device 202 is driven by a not-shown battery, and includes a plurality of buttons and keys with which a user makes operation inputs. When the user operates the buttons and keys on the operation device 202, the operation contents are transmitted to the game machine 200 wirelessly or by a wire.

The operation device 202 has an arrow key 216, joy sticks 218, and a group of operation buttons 220. The arrow key 216, the joy sticks 218, and the group of operation buttons 220 are arranged on a top surface 222 of the casing. The four types of operation buttons 224, 226, 228, and 230 are marked with different symbols in different colors in order to distinguish them from each other. More specifically, the operation button 224 is marked with a red circle, the operation button 226 is marked with a blue cross, the operation button 228 is marked with a purple square, and the operation button 230 is marked with a green triangle. A rear surface 232 of the casing of the operation device 202 is provided with a plurality of LEDs, not shown.

The user holds a left side grip portion 234b with the left hand, and a right side grip portion 234a with the right hand when operating the operation device 202. The arrow key 216, the joy sticks 218, and the group of operation buttons 220 are arranged on the top surface 222 of the casing so that they can be operated by the user who is holding the left side grip portion 234b and the right side grip portion 234a with the right and left hands.

An LED button 236 is also provided on the top surface 222 of the casing. The LED button 236 is used, for example, to display a particular menu screen on the television monitor 204 with the game machine 200. It also has the functions of indicating the battery level of the operation device 202 with the lighting status of the LED. For example, the LED is lit in red during charging, lit in green when fully charged, and blinks in red when the battery level is low.

The arrow key 216 is configured such that it can be pressed in four directions, i.e., up, down, right, and left directions, eight directions, i.e., up, down, right, and left directions and four directions therebetween, or in any direction. For example, the arrow key 216 is used to move in up, down, right and left directions a cursor on a screen of the television monitor 204, and scroll various kinds of information on the screen. Respectively different functions are allocated to the group of operation buttons 220 by an application program.

The joy joystick 218 has a stick supported in such a manner that the stick can be inclined in any direction, and has a sensor for detecting the amount of inclination. The stick is designed to return to a neutral position with the aid of an urging means such as a spring. The stick returns back to the neutral position when not operated. When the stick is inclined, the amounts of inclinations in a plurality of reference directions are converted into digital values, and the values are transmitted to the game machine 200 as an operation signal.

The operation device 202 further includes a select button 240, a start button 238, and the like. The start button 238 is used, e.g., when the user instructs the game machine 200 to start a program, and starts/pauses playing a movie or music. On the other hand, the select button 240 is used, e.g., when the user selects one of items of the menu displayed on the television monitor 204.

Now, the internal circuit configuration of the game machine 200 will be explained. As shown in FIG. 4, the game machine 200 includes, as its principal components, a main CPU 300, a GPU (graphic processing unit) 302, an input/output processor 304, an optical disk reproduction unit 306, a main memory 308, a mask ROM 310, and a sound processor 312. The main CPU 300 performs signal processing and control of various internal components based on various kinds of programs. The GPU 302 performs image processing. The input/output processor 304 performs interfacing or processing between the GPU 300 and some of the components in the apparatus and components outside of the apparatus. In addition, the input/output processor 304 may have functions for executing application programs, so that the game machine 200 has compatibility with other game machines.

The optical disk reproduction unit 306 reproduces an optical disk, such as a BD, DVD or CD, storing an application program or multimedia data. The main memory 308 serves as a work area for the main CPU 300 and a buffer for temporarily storing data read from an optical disk. The mask ROM 310 stores operating system programs to be executed mainly by the main CPU 300 and the input/output processing unit 304. The sound processor 312 performs audio signal processing.

The game machine 200 further includes a CD/DVD/BD processor 314, an optical disk reproduction driver 316, a mechanical controller 318, a hard disk drive 334, and a card-type connector (e.g., PC card slot) 320. The CD/DVD/BD processor 314 performs, e.g., error correction processing (e.g., CIRC (cross interleave Reed-Solomon coding)), expansion decoding processing, and so on, to a disk reproduction signal read from a CD, DVD, or BD by the optical disk reproduction unit 306 and then amplified by an RF amplifier 328, thereby reproducing data recorded on the CD, DVD, or BD. The optical disk reproduction driver 316 and the mechanical controller 318 perform rotation control of a spindle motor of the optical disk reproduction unit 306, focus/tracking control of an optical pickup, loading control of a disk tray, etc.

For example, the hard disk drive 334 stores saved data for programs and game programs read by the optical disk reproduction unit 306, or stores data such as photos, moving images, and music acquired via the input and output processor 304. The card-type connector 320 is a connection port for, e.g., a communication card, an external hard disk drive, or the like.

These internal components are connected with each other mainly through bus lines 322, 324, and the like. The main CPU 300 and the GPU 302 are connected through a dedicated bus. Additionally, the main CPU 300 and the input/output processor 304 are connected through a high-speed BUS. Likewise, the input/output processor 304, the CD/DVD/BD processor 314, the mask ROM 310, the sound processor 312, the card-type connector 320, and the hard disk drive 334 are connected through the high-speed BUS.

The main CPU 300 executes an operating system program for the main CPU 300 stored in the mask ROM 310 to control the operation of the game machine 200. Further, the main CPU 300 reads various kinds of programs and other data from an optical disk such as a BD, DVD-ROM, or CD-ROM and loads the programs into the main memory 308. Furthermore, the main CPU 300 executes the programs loaded to the main memory 308. Alternatively, the main CPU 300 downloads various kinds of programs and other data via the communication network, and executed the downloaded programs.

The input/output processor 304 executes an operating system program for the input/output processor stored in the mask ROM 310 to control data input/output with the operation device 202, a memory card 326, the USB connection terminal 208, Ethernet (registered trademark) 330, an IEEE 1394 terminal, not shown, and the PC card slot. Data input/output with the operation device 202 and the memory card 326 are controlled via the interface 232 including a multimedia slot and a wireless communication port.

The GPU 302 has a function of a geometry transfer engine for executing coordinate conversion and so on, and a function of a rendering processor. The GPU 302 draws an image in a frame buffer, not shown, according to rendering instructions given by the main CPU 300. For example, in the case where programs stored on an optical disk use 3D graphics, the GPU 302 calculates, in a geometry operation process, the coordinates of polygons to constitute a three-dimensional object. Further, the GPU 302 makes, in a rendering process, an image that may be obtained by shooting the three-dimensional object by a virtual camera. The GPU 302 writes the thus obtained image into the frame buffer. The GPU 302 then outputs a video signal corresponding to the stored image to the television monitor 204. Thus, an image is displayed on a screen 204b of the television monitor 204.

The sound processor 312 has an ADPCM (Adaptive Differential Pulse Code Modulation) decoding function, an audio signal reproducing function, and a signal modulating function. The ADPCM decoding function is a function for generating waveform data from sound data encoded with ADPCM. The audio signal reproduction function is a function for generating an audio signal for, e.g., sound effects, from waveform data stored in a sound buffer incorporated in or externally connected with the sound processor 312. Internal speakers 204a, 204a of the television monitor 204 output sound represented by an audio signal. The signal modulating function is a function for modulating waveform data stored in the sound buffer.

When the game machine 200 is turned on, the operating system programs for the main CPU 300 and the input/output processor 304 are read from the mask ROM 310. These operating system programs are executed by the main CPU 300 and the input/output processor 304. Thus, the main CPU 300 centrally controls each component of the game machine 200. On the other hand, the input/output processor 304 controls signal input/output between elements such as the operation device 202, and the memory card 326, and the game machine 200. Also, by executing the operating system program, the main CPU 300 performs initialization such as operation check and so on. The main CPU 300 then controls the optical disk reproduction unit 306 to read an application program for a game and the like from an optical disk. After loading the application program in the main memory 308, the main CPU 300 executes the program. By executing the application program, the main CPU 300 controls the GPU 302 and the sound processor 312 following the operator's

FIG. 5 is a functional block diagram of the user apparatus 12 and the server 14. As shown in the figure, the user apparatus 12 functionally includes a storing unit 30, an update unit 31, a query generation unit 32, a control unit 33, a reproduction unit 34, and a music list generation unit 35. A program to realize such elements are read from an optical disk by an optical disk reproduction unit 306, for example, and are installed into a hard disk drive 334. Or it is downloaded from another computer in a communication network via an ethernet 330. Meanwhile, the server 14 functionally includes a filter 41, a sorting by degree of similarity unit 42, a tentative music list generation unit 43 and a music distribution unit 44. Those elements are also realized by executing programs to be stored to store in the hard disk drive 73 by a processor 70.

Firstly, the server 14 includes the database 14a as described above, and this database 14a stores music feature data and music attribute data. As shown in FIG. 6, the music feature data is prepared for all music to be distributed, and includes music ID and feature quantity of a plurality of features. The music ID is information to identify respectively a lot of music distributed to a user by the content distribution system 10. Examples of features include a tempo of music, the degree how much a sound having a particular frequency is included in one music, and the degree how many times a particular keyword appears in an explanatory text of a song. These feature quantities may be input as a result of analytic processing performed by a computer. In the explanation below, a vector whose component is the feature quantity of a feature is described as a feature vector.

Further, as shown in FIG. 7, music attribute data is prepared for all music subject to be distributed, and it includes music ID and attributes values of a plurality of attribute. In this embodiment, a plurality of attributes suitable for representing features of each music, such as genre of music, sub-genre indicating sub group of the genre, artist name which is a singer or player of the music, year the music is published, related artists who are influential artists or close artists, melody of the music, are prepared in advance. Further, attribute values of such attributes are set in each of music in advance. Regarding attributes and attribute values, in a case where the attribute is a style of song, examples of attribute values include rock music, pop music, classical music, jazz music, and the like. In a case where the attribute is a year when an artist was a year, examples of attribute values include 1950, 1960, 1970, and the like. Some of attribute values of attributes (melody of music, for example) may be input as a result of analytic processing performed by a computer. However, most of the attributes are desirably input by a person.

In the present embodiment, query for favored music and query for non-favored music are transmitted from the user apparatus 12 to the server 14. The query for favored music includes filter data for selecting music according to attribute of each of music and favored music user vector for selecting user's favorite music according to features. Similarly, query for non-favored music includes non-favored music user vector for selecting user's non-favored music according to features.

In the filter 41 of the server 14, a part of music subject to be distributed is selected based on the filter data included in the query for favored music. Specifically, the filter data presents a conditional equation of the attribute value and searches music that satisfies this conditional equation by referring to the above-mentioned music attribute data. Then, it passes a music list that is found to the sorting by degree of similarity unit 42. The sorting by degree of similarity unit 42 calculates feature vector (obtained from the music feature data) of each music included in the found list and the degree of similarity to the favored music user vector included in the query for favored music, and sorts music in the list in decreasing order of similarity. Subsequently, the tentative music list generation unit 43 includes ID of a certain number of music on the tentative favored music list in decreasing order of similarity. The similarity may be distance between vector, or angle made by the vectors. In a case if the similarity is distance, as smaller the distance is, the higher similarity is. Further, as described later, in a case if the user vector is transmitted from a plurality of user apparatus 12, similarity to each user vector may be calculated similar to the above, and the highest similarity may be adapted among them.

Further, in the filter 41, a part of music subject to be distributed is selected based on the filter data included in the query for non-favored music. Then, it passes a music list that is found to the sorting by degree of similarity unit 42. The sorting by degree of similarity unit 42 calculates feature vector (obtained from the music feature data) of each music included in the found list and the degree of similarity to the non-favored music user vector included in the query for non-favored music, and sorts music in the list in the order from the highest similarity. Subsequently, the tentative music list generation unit 43 includes ID of a certain number of music in the tentative non-favored music list in decreasing order of similarity. The tentative favored music list and tentative non-favored music list which are obtained in this way are replied from the server 14 to the user apparatus 12.

Further, in the database 14a, audio data of a huge number of music (music data) is stored in relation with music ID, and when the music distribution unit 44 of the server 14 receives music ID from the user apparatus 12, it reads the music data stored in relation with the music ID from the database 14a, and replies it to the user apparatus 12.

Next, the storage unit 30 of the user apparatus 12 stores a favored music attribute 51, a non-favored music attribute 52, a short-term user vector 53, a long-term user vector 54 and SVM (Support Vector Machine: classifier) parameter 55. The favored music attribute 51 is to be stored incrementally to the storage unit 30 every time an user clearly specifies that the user likes it by pressing (operation of positive evaluation) a specific button (a button 224, for example) of the operation device 202, and includes attribute values of music that has been clearly specified that the user likes it, as shown in FIG. 8(a). Similarly, the non-favored music attribute 52 is to be stored incrementally to the storage unit 30 every time an user clearly specifies that the user dislikes it by pressing (operation of negative evaluation) a specific button (a button 226, for example) of the operation device 202, and includes attribute values of music that has been clearly specified that the user dislikes it, as shown in FIG. 8(b).

The short-term user vector 53 is, as shown in FIG. 9, an additionally and sequentially stored feature vector of music clearly specified that the user likes is by an operation of the operation device 202. On the other hand, the long-term user vector 54 includes, as shown in FIG. 10(a), an additionally and sequentially stored feature vector of music clearly specified that the user likes it by an operation of the operation device 202, and, as shown in FIG. 10(b), an additionally and sequentially stored feature vector of music clearly specified that the user dislikes it by an operation of the operation device 202. However, the short-term user vector 53 is to be deleted by the control unit 33 when it is satisfied with later-described condition to end related mode, therefore, the short-term user vector 53 stored in the storage unit 30 generally is less than the long-term user vector 54.

The SVM parameter 55 is a parameter indicating a state of SVM. The music list generation unit 35 includes function for determining whether a feature vector of an arbitrary music is a feature vector of music that the user likes or a feature vector of music that the user dislikes, using well known algorithm of SVM. The SVM parameter 55 is a variable that defines the state of SVM.

As described later, the user apparatus 12 includes three of action modes that are a specific mode, a related mode, and a search mode, and the query generation unit 32 generates queries for selecting music according to selection standard different in each mode. The specific mode is a mode for transitioning when a user operates positive evaluation for music the user currently reproducing, wherein a query for extracting music of the artist that the user recently clearly specified that the user likes it as a tentative favored music list. Further, the specific mode is a mode for transitioning when the specific mode is over, wherein a query for extracting music of the artist related to the artist whom the user recently clearly specified that the user likes as a tentative favored music list. The search mode is a mode for transitioning when the related mode is over, in which a query for widely extracting music likely of being favored by the user is created based on random numbers. The current action mode is controlled by the control unit 33 as described later, and notified the query generation unit 32.

The query generation unit 32 creates filter data for indicating processing of the filter 41. The filter data is configured from a filter ID and a filter parameter. Note that the filter data included in the query for favored music and the filter data included in the query for non-favored music may be the same and may not be the same. In the present embodiment, as shown FIG. 11(a) to (e), various conditional equation of the attribute values are prepared as filters, and the filter ID is information that identifies each conditional equation. Each conditional equation includes attribute values as variables, and filter parameters specify the valued of the variables. For example, the filter shown in FIG. 11(c) represents a conditional equation that values of year attribute is variable X. The query generation unit 32 includes the filter ID for identifying any filter, and filter parameters set as a variable in the conditional equation for the filter that is identified by the filter ID.

At this time, in the specific mode, the filter shown in FIG. 11(a) is used. As the variable X, the artist of music that the user recently operates the user's positive evaluation is set. This artist (name) is included in the favored music attribute lastly added to the storage unit 30. Thus selection is performed limiting the attribute of the artist. In addition, in the related mode, the filter shown in FIG. 11(b) is used. At this time, as the variable X, the artist of music that the user recently operates the user's positive evaluation is set. Thus selection is performed limiting the attribute of the artist. Further, in the search mode, one of the filters shown in FIG. 11(a) to (e) is randomly selected by random numbers. The value of variable X is also set randomly by random numbers. Note that as a filter parameter included in the query for favored music, the attribute value that is selected randomly included in the favored music attribute 51 may be the value of variable X. At this time, it may be preferable to select all kinds of attribute values included in the favored music attribute 51 in the same probability, or it may be preferable to select each kind of attribute values in a probability based on the number included in the favored music attribute. For example, in a case where attribute values for 10 music in total is stored in the favored music attribute 51 and as artist attribute, an attribute value A is recorded in 5 times, an attribute value B is recorded in 3 time, and an attribute value C is recorded in 2 times, those attribute values A to C may be selected in the same probability (⅓), or the attribute value A, the attribute value B, and the attribute value C may be selected respectively in one-half probability, three thenths probability, and one fifths probability. Further, as a filter parameter included in the query for non-favored music, the attribute value that is selected randomly included in the non-favored music attribute 52 may be the value of variable X

Further, the query generation unit 32 generates a favored music user vector and a non-favored music user vector. Specifically, in the specific mode and the related mode, one or more vectors in the short-term user vectors, or vectors generated by averaging the short-term user vectors may be set as favored music user vectors. Further, one or more vectors in the long-term user vector 54 related to non-favored music shown in FIG. 10(b), or vectors generated by averaging those long-term user vectors 54 may be set as non-favored music user vectors. Further, in the search mode, one or more vectors in the long-term user vector 54 related to favored music shown in FIG. 10(a), or vectors generated by averaging those long-term user vectors 54 may be set as favored music user vectors. Similarly, one or more vectors in the long-term user vector 54 related to non-favored music shown in FIG. 10(b), or vectors generated by averaging those long-term user vectors 54 may be set as non-favored music user vectors.

The query for favored music and the query for non-favored music generated as above are transmitted to the server 14. The server 14 responds this and sends a tentative favored music list and a tentative non-favored music list back. The music list generation unit 35 selects a predetermined number of music from the music included in the tentative favored music list, and generates a music list for reproduction including ID of those selected music. For example, among the music included in the tentative favored music list, music included in the non-favored music list is excluded from the music list for reproducing. For other music, SVM processing is performed using the SVM parameter 55 so as to determine whether the music is to be favored or non-favored by the user. Then, the music likely non-favored is also excluded from the music list for reproducing. Note that when performing the SVM processing, a feature vector of each of music that is subject to be determined may be obtained from the database 14a, for example. Further, similarity between a feature vector of each music remained and a feature vector of music recently reproduced in the user apparatus 12 is calculated to sort in the order from the highest similarity. Then, a predetermined number of music ID from the top may be included in the music list for reproducing.

The reproduction unit 34 receives the music list that is generated in this way, and transmits the music ID included therein to the server 14. The music distribution unit 44 of the server 14 receives the music ID, reads the music data related to the music ID from the database 14a, and sends it back to the user apparatus 12. The user apparatus 12 receives the music data to reproduce. If the operation device 202 is operated at the time of reproducing, the operation data that represents the content is passed to the update unit 31 and the control unit 33. The update unit 31 obtains the music ID of music currently being reproducing, and obtains the feature vector and the music attribute vector corresponding to the music ID thereof. They may be read from the database 14a of the server 14.

Further, the update unit 31 stores the obtained music attribute data as a favored music attribute 51, if the operation data represents that the user favors the music currently being reproduced. Further, the obtained feature vector is stored in the storage unit as a short-term user vector while the obtained feature vector is stored in the storage unit as a long-term user vector. In addition, the SVM parameter 55 is updated based on the obtained feature vector. Further, the update unit 31 stores the obtained music attribute data as a non-favored music attribute 52, if the operation data represents that the user does not favor the music currently being reproduced. Further, the obtained feature vector is stored in the storage unit 30 as a long-term user vector 54. In addition, the SVM parameter 55 is updated based on the obtained feature vector.

The control unit 33 manages an action mode of the current user apparatus 12 while instructing action modes of the query generation unit 32 and the music list generation unit 35. FIG. 12 is a diagram explaining management of action mode by the control unit 33. As described above, the user apparatus 12 includes three action modes, which are a specific mode, a related mode, and a search mode, and the default state is the mode instruction, for example. In the search mode, music with wide range of attributes and feature is provided to the user as described above. This mode continues until the user operates positive evaluation using the operation device 202 to the music being reproduced. If the user operates positive evaluation, the control unit 33 transitions the current action mode to the specific mode. In the specific mode, music of an artist who recently operates positive evaluation is to be provided to the user as described above. Moreover, if a predetermined completion condition is satisfied, for example, in a case reproducing music of all of the music ID included in the music list initially generated by the music list generation unit 35 has been completed, it transitions to the related mode.

In the related mode, music in which an artist who recently operates positive evaluation is set as an attribute value of the related artist is to be provided to the user as described above. In this mode, if the user operates positive evaluation, the control unit 33 transitions the current action mode to the user's positive evaluation. If the user operates negative evaluation, the control unit 33 transitions the current action mode to the search mode. If a predetermined completion condition is satisfied, for example, in a case where the music list generation unit 35 generates a predetermined number of music lists and completes reproducing the music of the music ID included in all lists, it transitions to the search mode.

Thus, if music with wide attributes and features are provided to the user in the search mode by transitioning and the user operates positive evaluation while reproducing any of the music, other music by the same artist of the music will be provided intensively. In addition, if the user operates negative evaluation or if the completion condition is satisfied before the user operates negative evaluation in the specific mode, it transitions to the related mode. And in the related mode, music by the related artist will be provided. In this related mode, if the user finds favorite music again and operates positive evaluation, it transitions to the specific mode again and other music by the same artist of the music will be intensively provided. In addition, if the user operates negative evaluation or if the completion condition is satisfied before the user operates negative evaluation in the related mode, it transitions to the search mode again. And music with wide attributes and features will be provided to the user.

According to the present embodiment, since the action mode is transitioned by the user's positive or negative evaluation and this changes selection standard for music accordingly, the user is likely to evaluate music willingly. In addition, if only music list is generated based on the long-term user vector, there may be little change in the content of the music list. On the contrary, according to the present embodiment, when the user operates positive evaluation, a music list is generated temporarily based on the short-term user vector, therefore, it becomes possible to provide the user with various music lists. Note that if time for operating in the search mode exceeds a predetermined time, or if the number of music provided exceeds a predetermined number, it may be possible to transition mandatorily to the specific mode or the related mode. In this case, it may store IDs of music to which the user operates positive evaluation sequentially so that the system may randomly select and apply one of the music whose music ID is stored, or an initial music prepared in advance, as a music that the user recently explicit that he/she likes, when transitioning mandatorily to the specific mode or the related mode.

Note that this invention is able to be realized in various variations. For example, in the above explanation, the server 14 has functions for retaining a lot of music data, generating a tentative favored music list and a tentative non-favored music list, however, the user apparatus 12 may have those functions. Or, the server 14 may has functions of the storage unit 30, the update unit 31, the query generation unit 32, the control unit 33, the music list generation unit 35, and the update unit 31. In this case, the music list generation unit 35 of the server 14 may transmit music list for reproducing to the user apparatus 12. In addition, the user apparatus 14 may transmit operation data that represents the user's positive and negative evaluation along with data specifying music currently being reproduced to the server 14.

Further, the user apparatus 12 may be realized using various kinds of hardware. For example, the user apparatus 12 may be realized using a portable game machine. FIG. 13 shows an external view illustrating a portable game machine. The portable game machine 400 reproduces digital contents such as movie, still image, music, and executes programs such as a game program. Each of contents is read from an external storage medium which can be attached to and removed from the portable game machine 400, or downloaded by data communication. The external storage medium according to the present embodiment may be a small optical disc 402 such as a UMD (Universal Media Disc) or a memory card 426. The optical disc 402 and the memory card 426 are respectively mounted on a drive device not shown arranged in the portable game machine 400. The optical disc 402 can store not only music data or still image data but also video data of contents in relatively huge data size, such as a movie. The memory card 426 is a small size memory card which can be attached to and removed from a digital camera or a cellular phone, and mainly stores data that the user created in another device, such as still image data, movie data, or audio data, and data to be transmitted between other devices.

The portable game machine 400 includes a crystal display 404, and operational parts such as a cross key 416, an analog stick 418, or a button 420. The user holds the both ends of the portable game machine 400 with his/her hands, indicates four directions using the cross key 416 or the analog stick 418 mainly by his/her left thumb, and operates various instructions using the button 420 mainly by his/her right thumb. A home button 436 is mounted, unlikely to the cross key 416 or the button 420, at a position hard to be pressed by any finger when the both ends of the portable game machine 400 are held with both hands for the purpose of preventing wrong operations. The crystal display 404 displays a menu screen and a reproducing screen of each of contents. The portable game machine 400 is mounted with communication functions via a USB port or wireless LAN, and transmits and receives data with other devices using those functions. Further, the portable game machine 400 includes a selection button 440, a start button 438. The start button 438 is a button for the user to give instructions such as starting a game, starting or pausing reproducing of contents such as a movie or music. The selection button 440 is a button for selecting menu items that are displayed on the crystal display 404.

FIG. 14 shows an internal circuit structure of the portable game machine 400. The portable game machine 400 is configured to include a control system 540 which consists of a CPU 541 and its peripheral devices or the like, a graphic system 550 which consists of a GPU 552 or the like that performs drawings to a frame buffer 553, a sound system 560 which consists of a SPU (sound processing unit) 561 for emitting music, effect sound, or the like, an optical disc control unit 570 for controlling the optical disc to which an application program is stored, a wireless communication unit 580, an interface unit 590, an operation input unit 502, and a bus or the like to which the above units are connected.

The sound system 560 includes the SPU 561 that emits music, sound effect or the like under control of the control system 540, the sound buffer 562 to which waveform data or the like is recorded, a speaker 544 that outputs music, sound effect or the like that the SPU 561 has emitted.

The SPU 561 has an ADPCM decoding function that reproduces ADPCM coded audio data, a reproducing function that emits sound effect or the like by reproducing the waveform data stored in the sound buffer 562, and a modulation function that modulates and reproduce the waveform data stored in the sound buffer 562.

The optical disc control unit 570 is connected with an optical disc apparatus 571 that reproduces data such as a program stored in an optical disc, a decoder 572 that decors data recorded with an error correction code (ECC), for example, and a buffer 573 that speeds up data reading from the optical disc by storing data from the optical disc apparatus 571 temporarily. The decoder 572 mentioned above is connected with a sub CUP 574.

An interface unit 590 includes a parallel I/O interface (PIO) 591, a serial I/O interface (SIO) 592. They are interfaces for connecting the memory card 426 and the portable game machine 400.

The operation input unit 502 supplies operational signals responding to the user's operation to the CPU 541. The wireless communication unit 580 communicates wirelessly via an infrared port or wireless LAN. The wireless communication unit 580 transmits data to other devices and receives data from other devices directly or through wireless communication network under control of the control system 540.

The graphic system 550 includes a geometry transfer engine (GTE) 551, a CPU 552, a frame buffer 553, an image decoder 554, and a crystal display 404.

The GTE 551 includes a parallel arithmetic architecture that executes a plurality of operations in parallel, and performs operations such as coordinate conversion, luminous source calculation, matrix or vector operation in high speed upon a request for operation from a main CPU 541. The control system 540 defines 3D model as a combination of basic primitive graphic (polygon), such as a triangle or rectangle based on the operation result of the GTE 551, and transmits a drawing instruction corresponding to each of polygon for drawing 3D image to the GPU 552.

The GPU 552 draws polygon against the frame buffer 553 in accordance with the drawing instruction from the control system 540. Further, the GPU 552 is capable of performing flat shading, Gouraud shading that compensates color of top of polygon and decide the color of inside of polygon, and texture mapping that posts texture stored in a texture region of the frame buffer to the polygon.

The frame buffer 553 stores image drawn by the GPU 552. The frame buffer 553 consists of so-called dual port RAM and is capable of performing drawing by the GPU 552 or transferring from the main memory 543 and reading for display at the same time. Further, the frame buffer 553 has a CLUT region that stores a color lock up table (CLUT) referred when the GPU 552 draws polygon or the like and the texture region mentioned above that stores texture other than a display region output as a video output. The CLUT region and texture region are dynamically changed in accordance with changes of the display region.

The display unit 3 displays images stored in the frame buffer 553 under control of the control system 540. The image decoder 554 decodes data of still image or video image that have been stored in the main memory and compressed and coded by orthogonal transform such as discrete cosine transform so as to store in the main memory 543, under control of the CPU 541 mentioned above.

The control system 540 includes the CPU 541, a peripheral device control unit 542 that performs interrupt control or control of direct memory access (DMA) transfer, or the like, the main memory 543 which consist of RAMs, and a ROM 545. The ROM 545 stores programs such as an operation system for controlling each unit of the portable game machine 500. The CPU 541 reads the operating system stored in the ROM 545 into the main memory 543, and controls the whole portable game machine 400 by executing the operating system that has been read. The user apparatus 12 can be realized by using the portable game machine 400 as described above.

Moreover, the user apparatus 12 can be realized by using a general use personal computer. FIG. 15 shows an internal circuit structure of a general use personal computer.

The general use personal computer includes a main CPU 600, a graphic processor unit 602, an input unit 604, an output unit 605, a drive 614, a main memory 608, and a ROM 610 as a basic structure. The main CPU 600 controls signal processing or internal structural elements based on programs such as an operating system or an application.

Each of these units is mutually connected with each other via a bus line 622. The bus line 622 is further connected with an input/output interface 632. The input/output interface 632 is connected with an output unit 605 that consists of a display and a speaker, an input unit 604 that consist of a keyboard, a mouse, a microphone, or the like, a communication unit 630 that consists of a peripheral device interface such as USB, IEEE 1394, or the like, or wired or wireless LAN network interface, and a drive 614 that drives a removable storage medium 626 such as an optical disc or a semiconductor memory.

The main CPU 600 controls the whole of the personal computer by executing the operating system stored in the storage unit 634. The main CPU 600 also executes various programs that has been read out from the removable storage medium 626 and loaded into the main memory 608, or downloaded via the communication unit 630.

The GPU 602 has a function of geometry transfer engine and a function of rendering processor, performs drawing processing following a drawing command from the main CPU 600, and stores the display image not shown frame buffer. The GPU 602 transforms and outputs the display image stored in the frame buffer. The user apparatus 12 can be realized by such a personal computer described above.
12 user apparatus
14 server
14a database
18 data communication network
30 storage unit
31 update unit
32 query generation unit
33 control unit
34 reproduction unit
35 music list generation unit
41 filter
42 sorting by degree of similarity unit
43 tentative music list generation unit
44 music distribution unit
51 favored music attribute
52 non-favored music attribute
53 short-term user vector
54 long-term user vector
55 SVM parameter

1. A content selection system comprising:
a content selecting device which selects more than one content from a plurality of contents using selectively and sequentially any one of a plurality of selection standards that are mutually different from each other; and
a controlling device which uses a selection standard different from a selection standard used for selecting said more than one content so that the content selecting selects more than one content from the plurality of contents when the content selecting uses any one of the selection standards and there is an operation to indicate a user's prescribed evaluation on any of more than one content to be reproduced.

2. The content selection system according to claim 1, wherein
when it is satisfied with condition to end content selection using any of the selection standard, the controlling device uses a selection standard different from said selection standard so that the content selecting device selects more than one content.

3. The content selection system according to claim 1 or 2, further comprising
a content reproducing device that reproduces said more than one content when the content selecting uses any of selection standards to select more than one content.

4. The content selection system according to any one of claims 1 to 3, wherein
the plurality of selection standards includes a first selection standard, and
the controlling device uses the first selection standard so that the content selecting device to select more than one content when there is an operation to indicate an user's positive evaluation on any of more than one content that is selected using a selection standard other than the first selection standard.

5. The content selection system according to claim 4, wherein
the first selection standard uses a first attribute of a content which corresponds to the operation indicating a positive evaluation.

6. The content selection system according to claim 4 or 5, further comprising
a short-term positive feature vector storing device that stores more than one short-term positive feature vector based on features of a content corresponding to each of more than one positive operation during a prescribed period after an operation indicating an user's positive evaluation,
wherein the first selection standard uses the more than one short-term positive feature vector that is stored by the storing device.

7. The content selection system according to any one of claims 4 to 5, wherein
the plurality of selection standards includes a second selection standard, and
the controlling device uses the second selection standard so that the content selecting device to select more than one content when ending reproducing of the more than one content that is selected using the first selection standard.

8. The content selection system according to claim 7, wherein
the content selection system uses a second attribute different from the first attribute of a content corresponding to the second selection standard and the operation indicating a positive evaluation.

9. The content selection system according to any one of claims 1 to 8, wherein
the plurality of selection standards includes a third selection standard, and
the controlling device uses the third selection standard so that the content selecting device to select more than one content when there is an operation to indicate an user's negative evaluation on any of more than one content that is selected using a selection standard other than the third selection standard.

10. The content selection system according to claim 9, wherein
the third selection standard uses random numbers.

11. A content selection method comprising:
a content selecting step which selects more than one content from a plurality of contents using selectively and sequentially any one of a plurality of selection standards that are mutually different from each other; and
a controlling step which uses a selection standard different from a selection standard used for selecting said more than one content so that the content selecting selects more than one content from the plurality of contents when the content selecting uses any one of the selection standards and there is an operation to indicate a user's prescribed evaluation on any of more than one content to be reproduced.

12. A content selection apparatus comprising:
a query generating device which generates a query to select more than one content from a plurality of contents using selectively and sequentially any one of a plurality of selection standards that are mutually different from each other; and
a controlling device that controls generating a query for selecting more than one content from the plurality of contents using a selection standard different from a selection standard used for selecting the more than one content when there is an operation which is selected by a query generated by the query generating device and which indicates a user's prescribed evaluation on any of the more than one content to be reproduced.

13. A program to cause a computer to function as:
a query generating device which generates a query to select more than one content from a plurality of contents using selectively and sequentially any one of a plurality of selection standards that are mutually different from each other; and
a controlling device that controls generating a query for selecting more than one content from the plurality of contents using a selection standard different from a selection standard used for selecting the more than one content when there is an operation which is selected by a query generated by the query generating device and which indicates a user's prescribed evaluation on any of the more than one content to be reproduced.
